(19) United States
(12) Patent Application Publication
(10) Pub. No.: US 2014/0032201 A1
(43) Pub. Date: Jan. 30, 2014

(54) METHOD FOR OPTIMIZING SENSE AMPLIFIER TIMING

(71) Applicants: Edward M. McCombs, Austin, TX (US); Alexander E. Runas, Austin, TX (US); Michael E. Runas, McKinney, TX (US)

(72) Inventors: Edward M. McCombs, Austin, TX (US); Alexander E. Runas, Austin, TX (US); Michael E. Runas, McKinney, TX (US)

(21) Appl. No.: 13/558,976

(22) Filed: Jul. 26, 2012

(51) Int. Cl. G06F 17/50

(52) U.S. Cl. 703/14

(57) ABSTRACT

Embodiments of a method are disclosed that may allow for the optimization of a memory circuit design parameter. The method may include the statistical simulation of one or more operational parameters of the memory circuit. Probabilities of the operational parameters achieving pre-defined probability goals may be used to optimize the memory circuit design parameter.

### BACKGROUND

1. Technical Field

This invention is related to the field of memory implementation, and more particularly to sensing techniques.

2. Description of the Related Art

Memories typically include a number of data storage cells composed of interconnected transistors fabricated on a semiconductor substrate. Such data storage cells may store a single data bit or multiple data bits and may be constructed according to a number of different circuit design styles. For example, the data storage cells may be implemented as a single transistor coupled to a capacitor to form a dynamic storage cell. Alternatively, cross-coupled inverters may be employed to form a static storage cell or a floating gate MOSFET may be used to create a non-volatile storage cell.

During the semiconductor manufacturing process, variations in lithography, transistor dopant levels, etc., may result in different electrical characteristics between transistors that are intended to have identical characteristics. This difference in electrical characteristics between transistors can result in data storage cells that output different small signal voltages for the same stored data. In a memory array, there may be a large variation in the output voltages across the data storage cells that make up the memory array.

Data from storage cells that generate a smaller than average output signal due to the previously described variation may not be able to be read correctly, resulting in a read failure. Data storage cells that fail to read properly may contribute to lower manufacturing yield. During the design process, a variety of circuit simulations may be performed on a memory that may model the variation in output signal from data storage cells. Circuit design parameters may be adjusted as a result of the simulation results in order maintain manufacturing yield goals.

### SUMMARY OF THE EMBODIMENTS

The present disclosure provides systems and methods for generating circuit design parameters. To that end, systems and methods disclosed herein provide the expression of algorithms that allow the optimization of circuit design parameters based upon the statistical analysis of the circuit.

In a non-limiting embodiment, the algorithm may generate a statistical distribution of first memory circuit design parameter and a second memory circuit design parameter. Probability density functions may be generated for each of the statistical distributions. The probability density functions may be combined to create a composite probability density function, which may be used to calculate the probability of a performance parameter achieving a pre-determined goal. A third design parameter may be optimized based upon the calculated probability.

In one implementation, the statistical distribution of the first memory circuit design parameter and the statistical distribution of the second memory circuit design parameter may be generated using Monte Carlo simulations. In some embodiments, the probability may be calculated by numerically integrating the composite probability density function.

In another non-limiting embodiment, the algorithm may employ the number of data storage cells and sense amplifiers in the calculation of the probability. The number of redundant data storage cells may also be employed in the calculation of the probability in some embodiments.

### BRIEF DESCRIPTION OF THE DRAWINGS

The following detailed description makes reference to the accompanying drawings, which are now briefly described.

FIG. 1 illustrates an embodiment of a memory circuit.

FIG. 2 illustrates an embodiment of a memory sub-array.

FIG. 3 illustrates an embodiment of a memory column.

FIG. 4 illustrates possible waveforms for the operation of the embodiment illustrated in FIG. 1.

FIG. 5 illustrates a possible method of designing the embodiment illustrated in FIG. 1.

FIG. 6 illustrates a possible method of performing a statistical simulation.

FIG. 7 illustrates a possible distribution of bit line output signal voltage.

FIG. 8 illustrates a possible distribution of the minimum input signal voltage necessary to operate a sense amplifier.

FIG. 9 illustrates a possible cumulative density function for a bit line output signal voltage.

FIG. 10 illustrates a possible method for optimizing the differential development time of the embodiment illustrated in FIG. 1.

FIG. 11 illustrates a possible method of determine the probability of encountering a misread while operating the embodiment illustrated in FIG. 1.

FIG. 12 illustrates a possible method of determining the distribution of minimum input signal voltage necessary to operate a sense amplifier.

FIG. 13 illustrates a possible method of determining the distribution of output signal voltage for a bit line.

FIG. 14 illustrates an embodiment of a computing system.

While the disclosure is susceptible to various modifications and alternative forms, specific embodiments thereof are shown by way of example in the drawings and will herein be described in detail. It should be understood, however, that the drawings and detailed description thereto are not intended to limit the disclosure to the particular form illustrated, but on the contrary, the intention is to cover all modifications, equivalents and alternatives falling within the spirit and scope of the present disclosure as defined by the appended claims. The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include,” “including,” and “includes” mean including, but not limited to.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. §112, paragraph six interpretation for that unit/circuit/component. More generally, the recitation of any element is expressly intended not to invoke 35 U.S.C. §112, paragraph six interpretation for that element unless the language “means for” or “step for” is specifically recited.

### DETAILED DESCRIPTION OF EMBODIMENTS

During the design of an integrated circuit, simulations to determine the performance of the integrated circuit may be performed. In some cases, these simulations may be performed at different fixed combinations of electrical characteristics of a semiconductor process. Such simulations are commonly referred to as “corner simulations.” Corner simulations, however, may not model on-chip or location variation within a circuit and, as such, may not provide an accurate measurement of the performance of an integrated circuit. Statistical simulations and analysis may be necessary to optimize circuit performance and limit yield loss. The embodiments illustrated below may provide techniques for statistical analysis and optimization of circuit design parameters. As used herein, the terms “optimize” and “optimization” refer to a goal-seeking process that attempts to identify a value that satisfies constraints or assumptions. It should be noted that an optimization process need not guarantee that a globally optimal result will be identified within a solution space. That is, depending on the characteristics of a given optimization process that produces a given optimized result, there may in fact exist other possible results that satisfy the constraints or assumptions to an even better degree than the given optimized results. Thus, as used herein, to “optimize” a parameter may refer to the process of refining the value through a goal-seeking process, rather than attempting to exhaustively ensure that no solution is superior to the solution identified by the process.

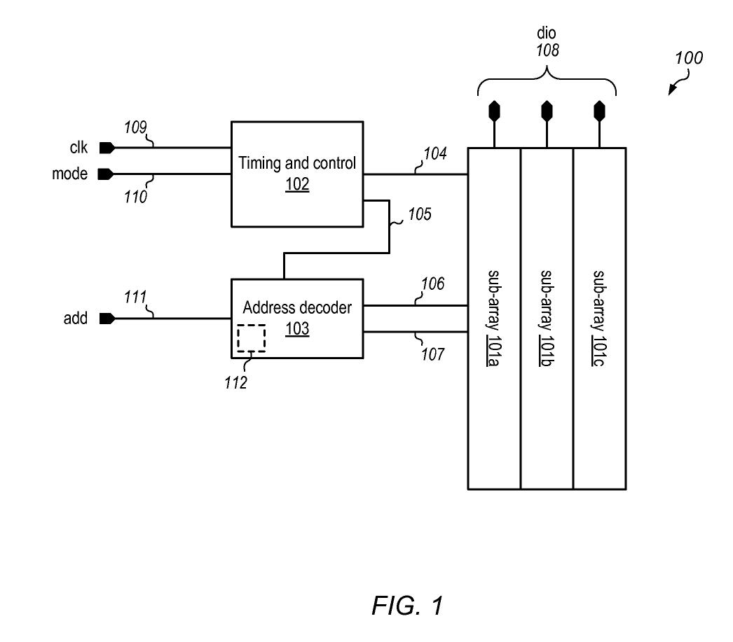

FIG. 1 illustrates a memory circuit according to one of several possible embodiments. In the illustrated embodiment, memory 100 includes a clock input 109 denoted as “clk,” a mode input 110 denoted as “mode,” an address input 111 denoted as “add,” and a data input output (I/O) 106 denoted as “dio.” Memory circuit 100 further includes sub-arrays 101a, 101b, and 101c, timing and control unit 102, address decoder 103, and address comparator 104. Timing and control unit 102 is coupled to provide a decoder enable signal 105 to address decoder 103, and control signals 104 to sub-arrays 101a, 101b, and 101c.

Address decoder 103 is coupled to provide row selects 106 and column selects 107 to sub-arrays 101a, 101b, and 101c, in response to the assertion of decoder enable signal 105 and the address value presented to address bus 111. In some embodiments, address decoder 103 may include a redundancy decoder 112, which may compare the address presented on address input 111 to a set of pre-determined addresses known to contain defective or weak data storage cells. In other embodiments, redundancy decoder 112 may assert one or row selects 106 and one of column selects 107 that are coupled to redundant data storage cells dependent upon the address presented on address input 111.

Timing and control unit 102 is coupled to provide control signals 104 to operate sub-arrays 101a, 101b, and 101c, as well as to provide decoder enable 105 to operate address decoder 103. In some embodiments, control signals 104 may include a sense amplifier enable signal, and a pre-charge control signal.

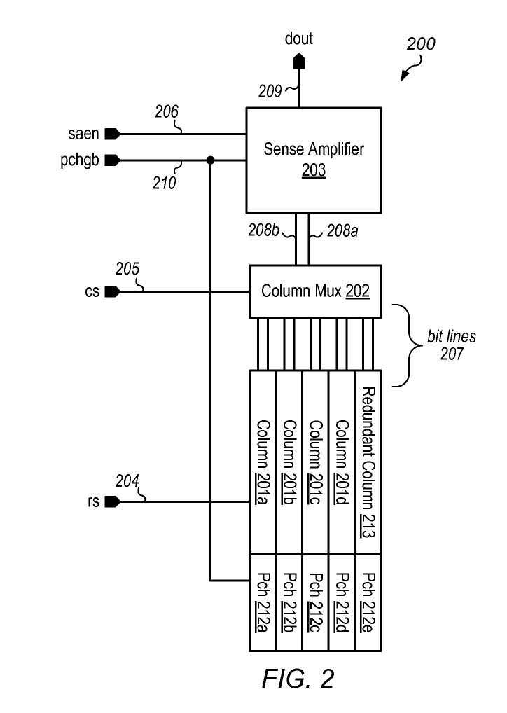

Turning to FIG. 2, an embodiment of a memory sub-array is illustrated. In some embodiments, sub-array 200 may correspond to sub-arrays 101a, 101b, and 101c of memory 100 illustrated in FIG. 1. Sub-array 200 includes a sense amplifier enable input 206 denoted as “saen,” a pre-charge enable input 210 denoted as “pchgb,” one or more column selection inputs 205 denoted as “cs,” one or more row selection inputs 204 denoted as “rs,” and a data output 209 denoted as “dout.” In some embodiments, column selection inputs 205, and row selection inputs may respectively correspond to column selects 107, and row selects 106 of memory 100 illustrated in FIG. 1. In other embodiments, sense amplifier enable input 206, and pre-charge enable input 210 may correspond to control signals 104 of memory 100 illustrated in FIG. 1.

In the illustrated embodiment, columns 201a, 201b. 201c, 201d, and redundant column 213 are coupled to the input of column multiplexer 202 through bit lines 207. Redundant column 213 may be used in place of one of columns 201a, 201b, 201c or 201d, in the case where one of columns 201a, 201b, 201c, or 201d contain one or more defective or weak data storage cells. The output of column multiplexer 202 is coupled to the input of sense amplifier 203 through differentially encoded nodes 208a and 208b. The output of sense amplifier 203 is coupled to data output 209. Pre-charge circuits pch 212a, 212b, 212c, 212d, and 212e are coupled to columns 201a, 201b, 201c, 201d, and redundant column 213, respectively, through bit lines 207, and are controlled by pre-charge enable input 210.

In some embodiments, column multiplexer 202 may contain one or more pass gates controllable by column selection inputs 205. The input of each pass gate may be coupled to the either the true or complement bit line output from one of columns 201a, 201b, 201c, and 201d. The output of each pass gate coupled to a true bit line may be coupled to the true output of column multiplexer 202 in a wired-OR fashion, and the output of each pass gate coupled to a complement bit line may be coupled to the complement output of column multiplexer 202 in a wired-OR fashion. In other embodiments, column multiplexer 202 may contain one or more logic gates configured to perform the multiplexer selection function.

It is noted that a pass gate (also referred to as a “transmission gate”) may include an n-channel metal oxide field effect transistor (MOSFET) and a p-channel MOSFET connected in parallel. In other embodiments, a single n-channel MOSFET or a single p-channel MOSFET may be used as a pass gate. It is further noted that, in various embodiments, a “transistor” may correspond to an individual transistor or other switching element of any suitable type (e.g., a field-effect transistor (FET)), or to a collection of transistors.

Sense amplifier 203 may use single-ended or differential analog amplification techniques in some embodiments. In other embodiments, sense amplifier 203 may employ a latch-based amplification technique or any other arrangement of transistors configured to amplify the voltage difference between nodes 208a and 208b. In some embodiments, sense amplifier 203 may include pre-charge transistors controlled by pre-charge enable input 210 configured to pre-charge nodes 208a and 208b.

Pre-charge circuits pch 212a, 212b, 212c, and 212d may contain one or more p-channel MOSFETs coupled to bit lines 207 and controlled by pre-charge enable input 210. It is noted that in other embodiments, other types and configurations of transistors may be employed to pre-charge bit lines 207.

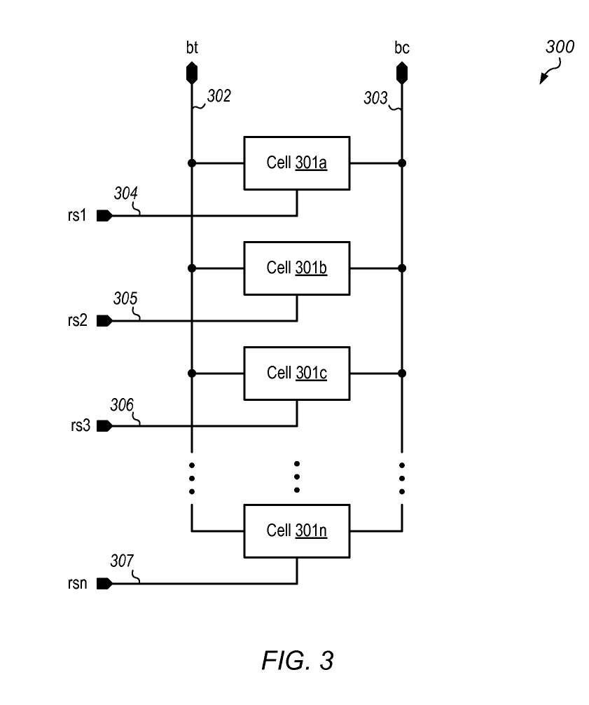

A memory column is illustrated in FIG. 3. In some embodiments, column 300 may correspond to columns 201a, 201b, 201c, 201d, and redundant column 213 in sub-array 200 in FIG. 2. Column 300 includes a true bit line I/O 302 denoted by “bt,” a complement bit line 303 denoted by “bc,” and a set of row select inputs 304, 305, 306, and 307, denoted by “rs1,” “rs2,” “rs3,” and “rsn,” respectively.

In the illustrated embodiment, data storage cell 301a is coupled to true bit line I/O 302 and complement bit line I/O 303, and is controlled by row select 304. In a similar fashion, data storage cells 301b, 301c, and 301n are coupled to true bit line I/O 302 and complement bit line I/O 303, and are each controlled by row select 305, row select 306, and row select 307, respectively. In the illustrated embodiment, data storage cells 301a, 301b, 301c, and 301n may be static storage cells, while in other embodiments, the data storage cells may be dynamic storage cells, ferroelectric storage cells, phase change storage cells, single-bit or multi-bit non-volatile storage cells, or mask programmable read-only storage cells. It is noted that in some embodiments, the data storage cells may transmit data in a single-ended fashion. In such cases, only a single bit line per column is required.

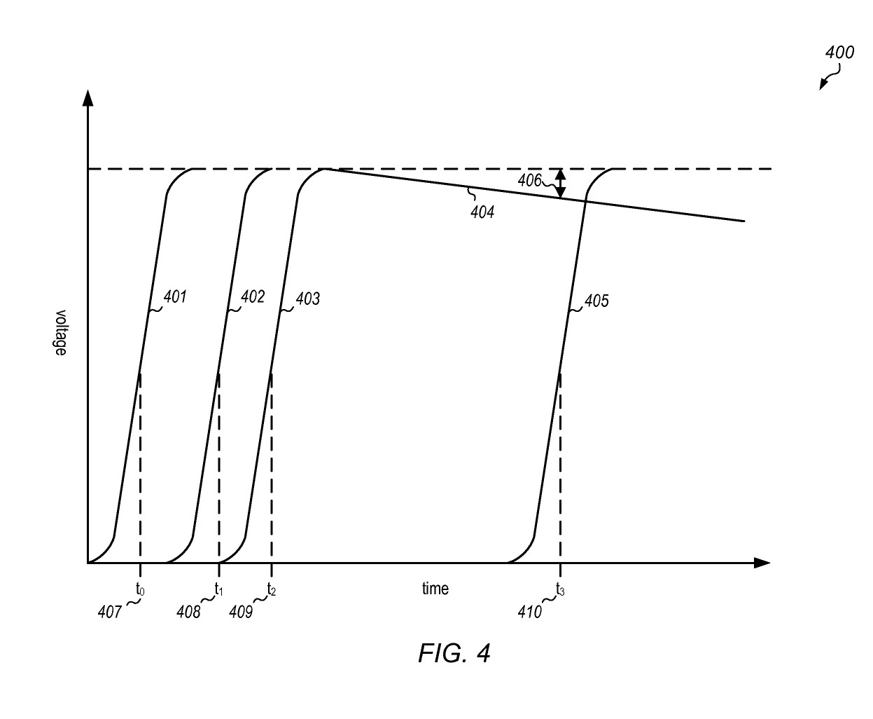

FIG. 4 illustrates possible waveforms resulting from the operation of memory 100 in FIG. 1. Referring collectively to FIG. 1, FIG. 2, FIG. 3, and the waveforms illustrated in FIG. 4, a read operation begins with memory 100 in pre-charge and clock input 109 low. At time t₀ 407, clock input 109 (waveform 401) is set high, mode 110 is set to select a read operation, and an address value is presented to address input 111. In response to clock input 109 being set high, timing and control unit 102 asserts decoder enable 105, which, in turn, activates address decoder 103. The address presented on address input 111 is then decoded by address decoder 103, which then asserts one of row selects 106 (waveform 402) at time t₁ 408 and one of column selects 107 (waveform 403) at time t₂ 409. It is noted that in this embodiment, low refers to a voltage at or near ground potential and high refers to a voltage sufficiently large to turn on n-channel MOSFETs and turn off p-channel MOSFETs.

With one of row selects 106 asserted, data storage cells, coupled to the asserted row select begin to discharge either the true or complement bit line coupled to the cell. For example, in FIG. 3, when rs1 304 is asserted, data storage cell 301a will begin to discharge either true bit line 302 or complement bit line 303 dependent upon the value of the data stored. In each of sub-arrays 101a, 101b, and 101c, the activated data storage cells each column, such as columns 201a, 201b, 201c, 201d, and redundant column 213, will begin to develop signal voltages on bit lines 207. When one of column selects 107 is asserted, a selected signal voltage from one of bit lines 207 may be coupled to nodes 208a and 208b (waveform 404), through column mux 202 generating differential signal voltage 406.

At time t₃ 410, sense amplifier enable signal 206 is asserted, activating sense amplifier 203, thereby amplifying differential signal 406. In some embodiments, sense amplifier enable signal 206 may correspond to one of control signals 104. The time from when one of row selects 106 is asserted to the time when sense amplifier enable signal 206 is asserted corresponds to the amount of time the selected data storage cell has to develop signal (differential signal voltage 406) and is commonly referred to as the “development time.”

In some cases, differential signal voltage 406 may not be sufficiently large for sense amplifier 203 to properly amplify, resulting in a read failure which is commonly referred to as a “misread.” The reduced signal may be the result of manufacturing variation in data storage cells, such as, e.g., data storage cells 301a through 301n. In other cases, manufacturing variation may cause sense amplifier 203 to have reduced gain or, in the case of a differential amplifier, an imbalance between the two inputs of the amplifier, which may result in a misread. In some embodiments, the development time may be adjusted to allow data storage cells more time to generate signal which may help reduce the occurrence of misreads.

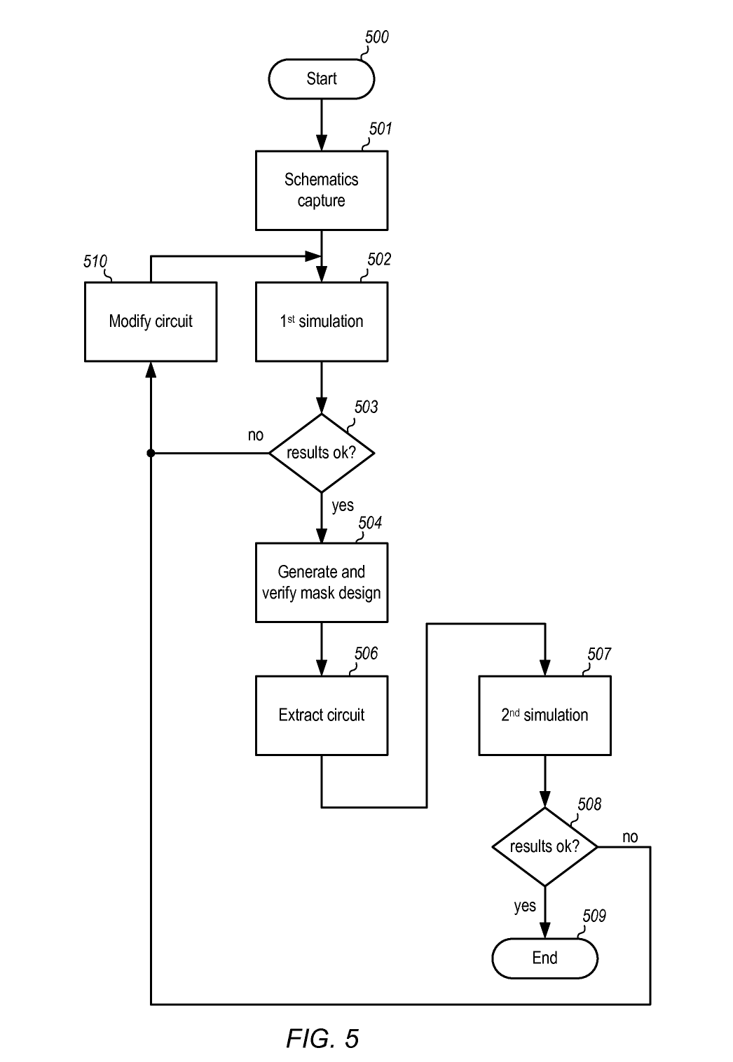

Turning to FIG. 5, a possible method of designing memory circuit 100 illustrated in FIG. 1. The method begins in block 500. Schematics defining memory circuit 100 are entered into a computer-aided design (CAD) system (commonly referred to as “schematics capture”) such as, e.g., Cadence Virtuoso™ (block 501). In some embodiments, netlists describing circuit elements, such as, e.g., MOSFETs, and the interconnection between circuit elements, may be written by a circuit designer in lieu of entering schematics into the CAD system. Once the schematics have been captured, a first simulation is performed (block 502) using a transistor-level simulator such as HSPICE™. In some embodiments, the first simulation may be a fixed corner simulation, while, in other embodiments, the first simulation may include statistical simulations.

The method then depends on the result of the simulations. When the simulation result indicates memory circuit 100 is not functioning correctly, modifications may be made using the CAD system to the schematics (block 501) and the first simulation performed again (block 502). When the simulation result indicates that memory circuit 100 is functioning correctly (block 503), the mask design for memory circuit 100 is drawn and verified (block 504). In some embodiments, the verification of the mask design may include performing layout-vs-schematics (LVS) checks, as well as, design rules checks (DRCs).

The mask design for memory circuit 100 is then extracted (block 506) to produce an extracted netlist that may include parasitic circuit elements such as resistors and capacitors that are representative of the interconnect wiring within the memory circuit. Mask design specific parasitic parameters for MOSFETs, such as, e.g., stress, strain, and well-proximity, may also be included in the extracted netlist. A second simulation is then performed (block 507) using the extracted netlist. The method then depends on the result of the second simulation. When the result of the second simulation indicates the circuit is not functioning correctly, memory circuit 100 is modified (block 510) and the method repeats using the modified circuit. In some embodiments, the modifications to memory circuit 100 may include an adjustment to the development time, while, in other embodiments, adjustments may be made to the gain of the sense amplifiers, such as sense amplifier 203 illustrated in FIG. 2. When the result of the second simulation indicates that the circuit is functioning correctly, the method ends (block 509). It is noted that in the illustrated embodiment, some or all of operations may occur in a different order than shown, or may occur concurrently rather than sequentially.

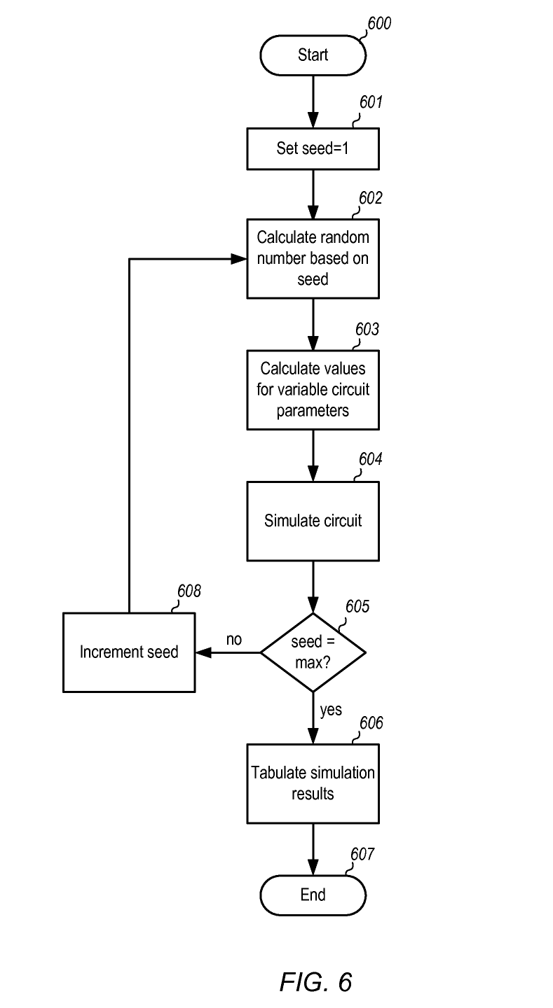

FIG. 6 illustrates a possible embodiment of performing a statistical simulation of a circuit such as memory circuit 100 illustrated in FIG. 1. Such simulations are often referred to as “Monte Carlo” simulations. The method begins in block 600. A seed value is set equal to one (block 601) and then a random number is calculated based on the seed value (block 602). In some embodiments, the random number may be calculated using a pseudo-random number generator such as, e.g., a linear congruential generator. Using the random number, values for variable circuit parameters are calculated (block 603). The variable circuit parameters may include parameters controlling the electrical characteristics of individual MOSFETs, such as, e.g., threshold voltage, as well as parameters controlling the values of parasitic resistors and capacitors. Some parameters may vary from one MOSFET instance to another within the netlist to model local variation across and integrated circuit due to such effects as random dopant fluctuations. In other embodiments, parameters governing the operating conditions of the simulations, such as, e.g., supply voltage and temperature, may also be calculated based on the random number.

The circuit is then simulated using the values calculated for the variable circuit parameters (block 604). The method is then dependent upon the value of the seed (block 605). When the value of the seed is less than a maximum value, the value of seed is incremented (block 608) and a new random number is calculated (block 602). When the value of the seed equals the maximum value, the results from the simulations performed at each seed value are tabulated (block 606) and the method completes (block 607). The method illustrated in FIG. 6 is exemplary in nature and other operations and order of operations are possible and contemplated.

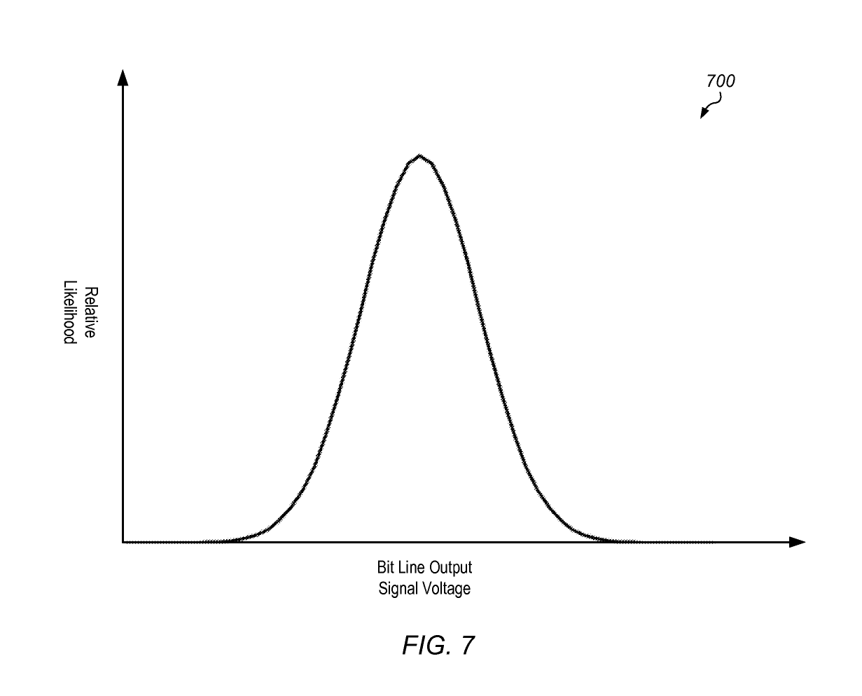

Turning to FIG. 7, a distribution of relative likelihood of bit line output signal differential is illustrated. When a statistical simulation, such as what was described in reference to FIG. 6, is performed, measurements may be made on a variety of operational circuit parameters such as voltages, currents, and relative timing differences between signal voltages. When the measurements are tabulated, the relative likelihood of detecting a given value of voltage or current can be illustrated graphically such as in FIG. 7. In this example, a graph showing the relative likelihood of bit line output signal voltages is illustrated. In some embodiments, the bit line output signal voltages may correspond to differential 406 illustrated in FIG. 4.

In the example illustrated in FIG. 7, the distribution of bit line output signal voltages are distributed in a normal (commonly referred to as “Gaussian”) fashion. In some embodiments, the bit line output signal voltages may be used to determine coefficients in the probability density function (PDF) for a Gaussian distribution as shown in Equation 1. The process of determining the coefficients, for example, μ and σ in Equation 1, is commonly referred to as “curve fitting” and may be performed using least squares fitting or any other equivalent algorithm. Once the coefficients have been determined, the PDF may be used to calculate the relative likelihood of a measurement point not directly determined by simulation. In other embodiments, the PDF may be integrated to calculate probabilities of specific measurement values.

$$ϕ ( x ) = \frac{1}{σ \sqrt{2 π}} {e}^{- \frac{1}{2} \text{?}} \\ \text{?} \text{indicates text missing or illegible when filed} \qquad ( 1 )$$

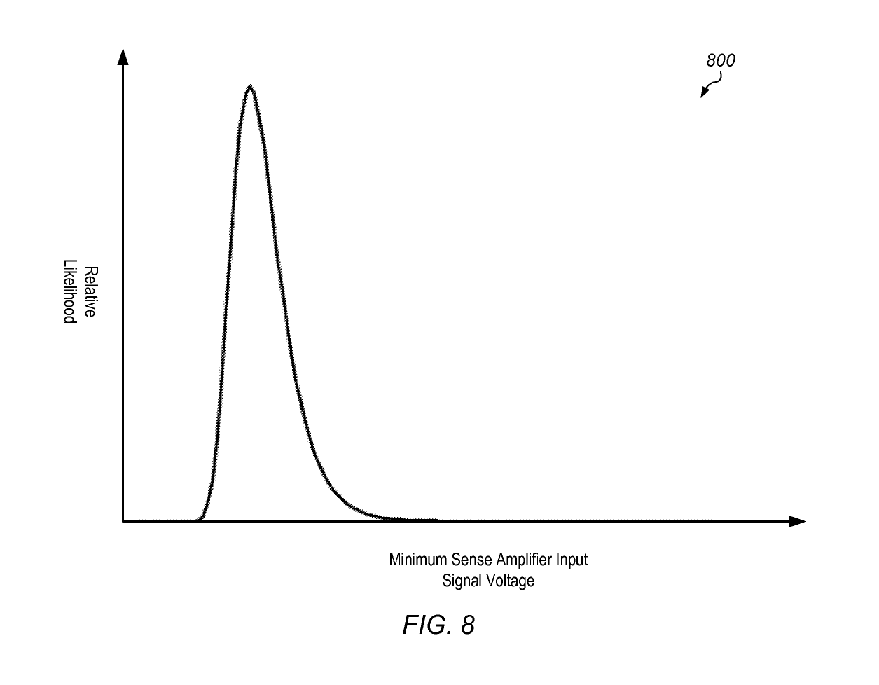

In many cases, the circuit parameters measured during statistical simulations will be distributed in a Gaussian function. Some circuit parameters, however, may require different PDFs. FIG. 8 illustrates the distribution of minimum sense amplifier input signal voltage. In some embodiments, the minimum sense amplifier input signal voltage may correspond to the voltage difference between nodes 208a and 208b necessary for sense amplifier 203 in FIG. 2 to correctly determine the encoded data. Distributions of the maximum or minimum of a parameter may be represented using one of the extreme value PDFs, such as, e.g., the Gumbel distribution (illustrated in Equation 2). As with the Gaussian PDF, the coefficients, α and β, for the Gumbel PDF can be determined using curve fitting techniques.

$$ψ ( x ) = \frac{1}{β} exp [ \frac{x - α}{β} - exp ( \frac{x - α}{β} ) ] \qquad ( 2 )$$

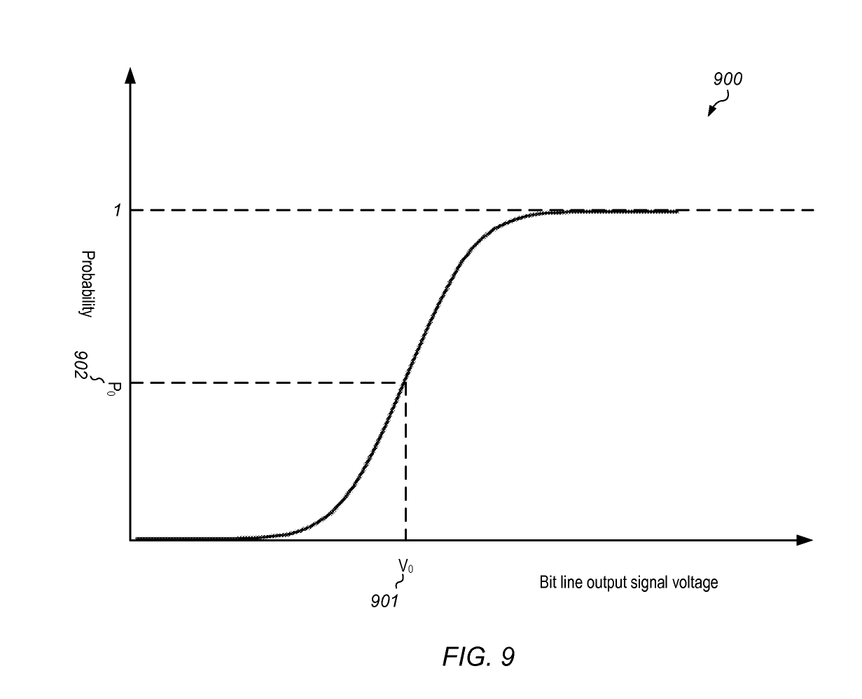

Turning to FIG. 9, an exemplary graph of a cumulative distribution function (CDF) for bit line output signal voltage is illustrated. In some embodiments, the illustrated CDF may correspond to the cumulative probability of the PDF illustrated in FIG. 7. A CDF may be used to determine the probability of detecting a given value of the measured circuit parameters such as, e.g., bit line output signal voltage. For example, the probability of detecting bit line output signal voltage V₀ 901 or lower is P₀ 902.

A CDF may be generated by integrating a PDF. For example, Equation 3 illustrates the integration of a Gaussian PDF to obtain corresponding CDF. A similar integral may be performed to generate a Gumbel CDF from a Gumbel PDF. In some embodiments, the integral may have a closed form solution and may be computed by hand. In other embodiments, the integral may be computed using Simpson's Rule or any other suitable numerical integration algorithm.

$$Φ ( x ) = \frac{1}{σ \sqrt{2 π}} {\int }_{- ∞}^{x} {e}^{- \frac{1}{2} \text{?}} d z \\ \text{?} \text{indicates text missing or illegible when filed} \qquad ( 3 )$$

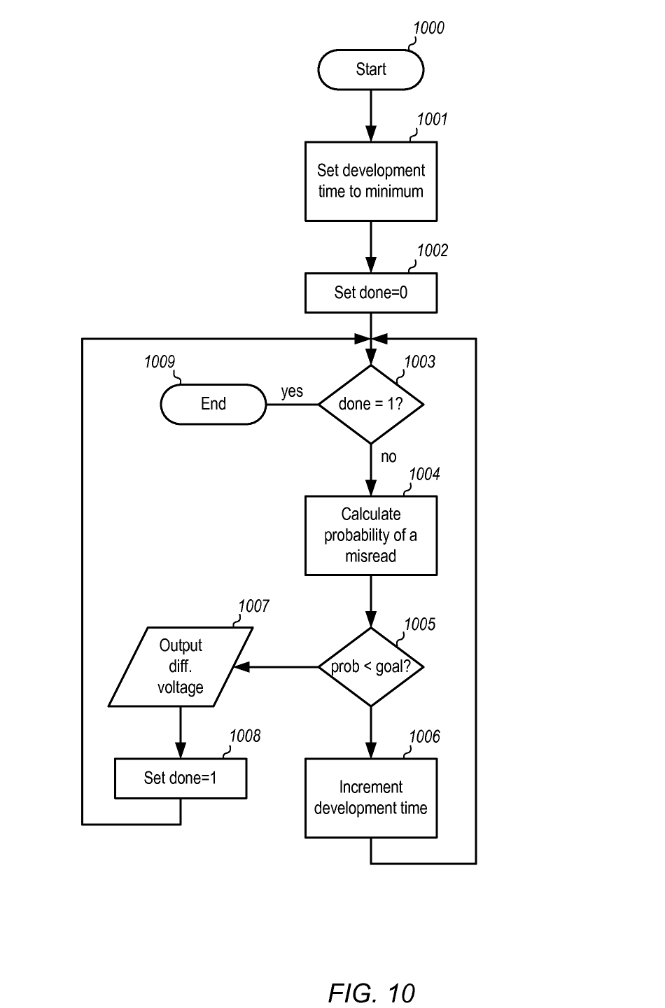

FIG. 10 illustrates a possible method of optimizing the differential development time for memory circuit 100 illustrates in FIG. 1. The method begins in block 1000. Timing and control block 102 is initially adjusted for the minimum differential development (block 1001). A done variable is then set to zero (block 1002). The method is then dependent on the status of the done variable (block 1003). When the done variable is equal to one, the method finishes (block 1009).

When the done variable is not equal to one, the probability of memory 100 generating a misread is determined (block 1004). In some embodiments, the probability may depend upon the number of sense amplifiers, data storage cells, and redundant data storage cells contained in memory 100. In other embodiments, the probability of other performance parameters, such as, e.g., access time, may be used instead of, or in conjunction with the probability of generating a misread. The method then depends on the value of the calculated probability (block 1005). When the calculated probability is greater than or equal to a pre-determined probability goal, the output differential signal voltage is saved (block 1007) and the done variable is set to one, which triggers completion of the optimization method.

In some embodiments, the pre-determined probability goal may be calculated using a desired manufacturing yield and the number of instances of memory 100 on an integrated circuit. When the calculated probability is less than the pre-determined probability goal, timing and control circuit 102 is adjusted to increase the differential development time (block 1006).

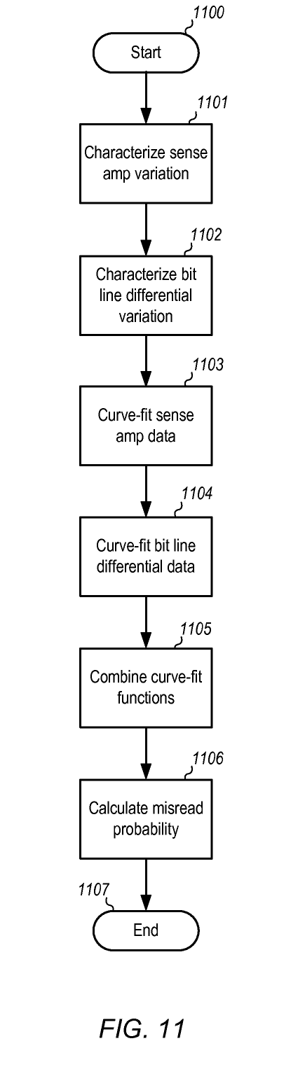

Turning to FIG. 11, a possible method of determining the probability of memory circuit 100 generating a misread is illustrated. In some embodiments, the method illustrated in FIG. 11 may correspond to the determine probability of a misread operation (block 1004) in the method of optimizing memory circuit 100 illustrated in FIG. 10. The method begins in block 1100. The variation of sense amplifiers contained in memory circuit 100 is then characterized (block 1101) using a statistical simulation. In a similar fashion, the variation of bit line differential signal voltages in memory circuit 100 are then characterized (block 1102) using a statistical simulation.

The resultant data from the statistical sense amplifier simulation is then curve fit to a PDF (block 1103). In some embodiments, the PDF may be a Gumbel PDF or any other suitable extreme value PDF. The resultant data from the statistical simulation of the bit line differential signal voltages is then curve fit to a PDF (block 1104). In some embodiments, the PDF may be a Gaussian PDF. The sense amplifier variation PDF and the bit line differential signal voltage variation PDF are then combined (block 1105). The two PDFs may be combined by multiplication, or, in other embodiments, the sense amplifier variation PDF may be modified dependent upon the number of sense amplifiers contained in memory circuit 100, and the bit line differential signal voltage variation PDF may be modified dependent upon the number of data storage cells contained in memory circuit 100, prior multiplying the two PDFs.

The probability of a misread occurring in memory circuit 100 is then calculated (block 1106) and then the method completes (block 1107). In some embodiments, the probability is calculated by integrating the combined PDF. In other embodiments, the sense amplifier variation PDF and the bit line differential signal voltage variation PDF are integrated separately and the resultant probabilities are combined in accordance with the rules governing probability. Numerical integration techniques may be used to perform the integration in some embodiments, while, in other embodiments, the integration may be performed by hand. It is noted that the method illustrated in FIG. 11 is exemplary in nature and the individual operations may occur in a different order or simultaneously in other embodiments.

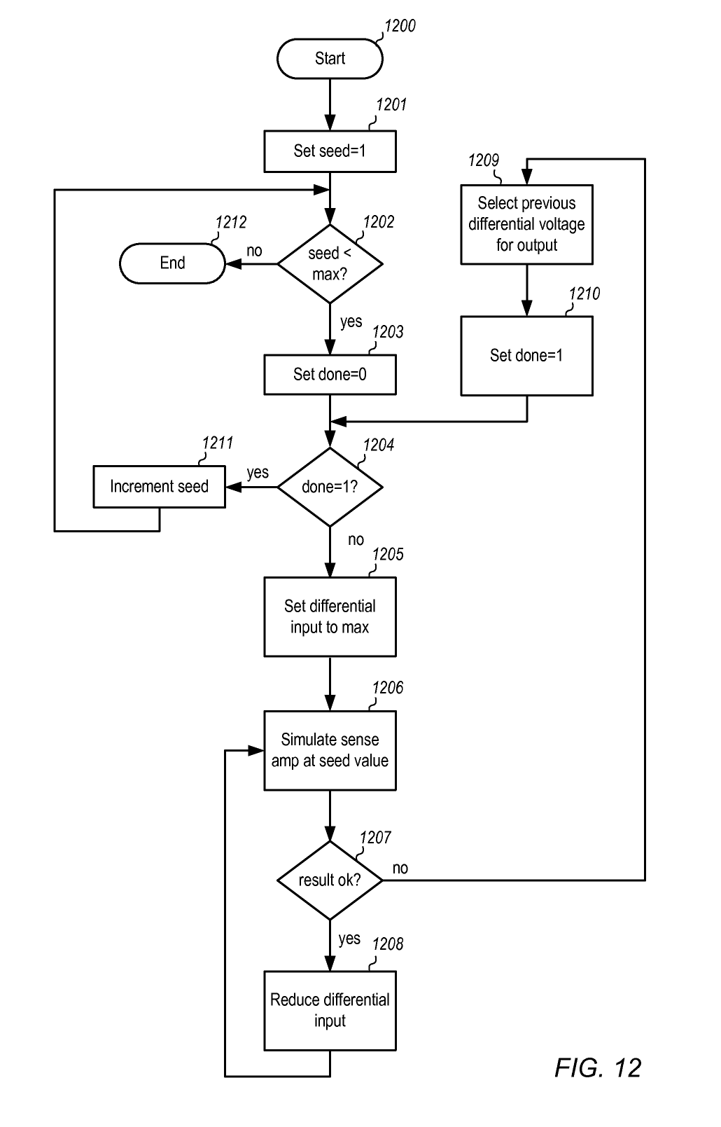

FIG. 12 illustrates a possible method for characterizing variation in the minimum required sense amplifier input signal. In some embodiments, the method illustrated in FIG. 12 may correspond to operation described for block 1101 in FIG. 11. The method begins in block 1200. The seed variable is then set to one (block 1201). The method is then dependent upon the value of the seed variable (block 1202). When the seed variable is greater than or equal to a maximum seed value, the method concludes (block 1212).

When the seed value is less than the maximum seed value, a done variable is set to zero (block 1203). The method then depends on the value of the done variable (block 1204). When the done variable is equal to one, the value of the seed variable is incremented (block 1211), and the value of the seed variable is checked against the maximum seed value (block 1202). When the done variable is equal to zero, the differential input voltage to the sense amplifier is set to a maximum value (block 1205). The sense amplifier is then simulated (block 1206) using the value of the seed variable to calculate a random number in a similar fashion to the previously described statistical simulation method illustrated in FIG. 4.

The method then depends on the result of the simulation (block 1207). When the result of the simulation indicates that the sense amplifier can properly detect the data state encoded by the differential input voltage, the differential input voltage is reduced (block 1208) and the sense amplifier is simulated with the new differential input voltage (block 1206). In some embodiments, the differential input voltage may be reduced by a fixed amount, while, in other embodiments, the differential input voltage may be reduced in accordance with an algorithm such as, e.g., a bisection algorithm.

When the result of the simulation indicates that the sense amplifier cannot properly detect the data state encoded by the differential input voltage, the previously simulated differential input voltage is saved for output (block 1209). The done variable is then set to one (block 1210) and the value of the done variable is then checked (block 1204). The method illustrated in FIG. 12 is exemplary in nature and different operations and different order of operations are possible and contemplated.

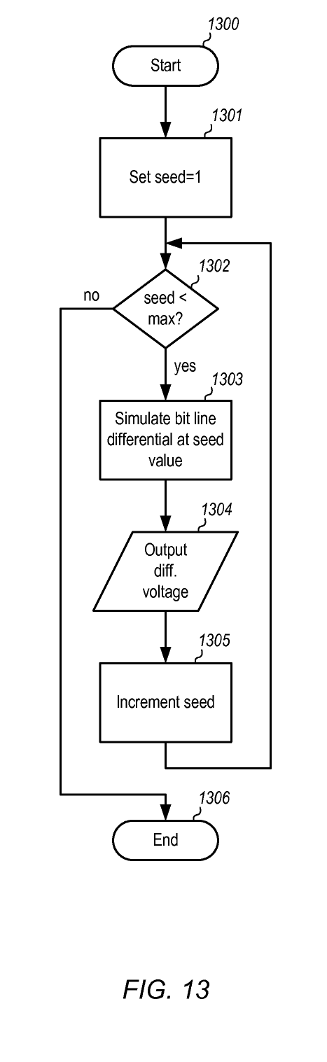

A method of characterizing the variation in bit line differential is illustrated in FIG. 13. In some embodiments, the method illustrated in FIG. 13 may correspond to operation described for block 1102 in FIG. 11. The method begins in block 1300. The value of a seed variable is then set to one (block 1301). The method then depends on the value of the seed variable (block 1302). When the value of the seed variable is greater than or equal to a maximum seed value, the method concludes (block 1306).

When the value of the seed variable is less than the maximum seed value, the bit line differential value is simulated (block 1303) using the value of the seed variable to calculate a random number in a similar fashion to the previously described statistical simulation method illustrated in FIG. 4. The simulated bit line differential value is then output (block 1304). The value of the seed variable is then incremented (block 1305) and the updated value of the seed variable is checked (block 1302).

In some embodiments, each simulation, as described above in reference to block 1303, may occur sequentially on a single computer or workstation. In other embodiments, one or more of the aforementioned simulations may occur simultaneously on one or more respective computers, workstations, or processor cores. It is noted that while the previously described analysis methods have been described in regards to optimization of memory circuits, in some embodiments, the methods may be used in the optimization of other types of circuits and operational parameters, such as, e.g., setup and hold times of flip-flops.

The method illustrated in FIG. 13 is merely an example of a possible method for characterizing the statistical variation of the bit line differential value. In other embodiments, the illustrated operations may be executed in a different order, and the inclusion of different operations may be possible.

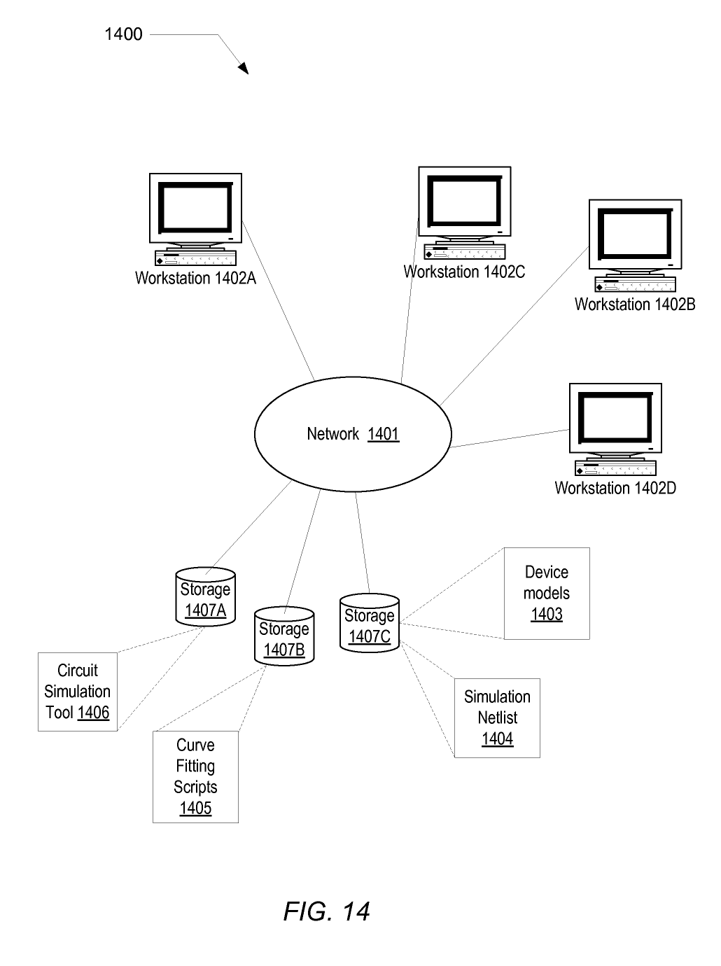

Turning to FIG. 14, a block diagram of one embodiment of a computer system including an integrated circuit design tool is illustrated. The computer system 1400 includes a plurality of workstations designated 1402A through 1402D. The workstations are coupled together through a network 1401 and to a plurality of storages designated 1407A through 1407C. In one embodiment, each of workstations 1402A-1402D may be representative of any standalone computing platform that may include, for example, one or more processors, local system memory including any type of random access memory (RAM) device, monitor, I/O devices such as a network connection, mouse, keyboard, monitor, and the like (many of which are not shown for simplicity).

In one embodiment, storages 1407A-1407C may be representative of any type of mass storage device such as hard disk systems, optical media drives, tape drives, ram disk storage and the like. As such, program instructions comprising the design tools such as curve fit scripts may be stored within any of storages 1407A-1407C and loaded into the local system memory of any of the workstations during execution. As an example, as shown in FIG. 14, the circuit simulation tool 1406 is shown stored within storage 1407A, while the simulation netlist 1404 and the device models 1403 are stored within storage 1407C. Further, curve fit scripts 1405 are stored within storage 1407B. Additionally, the program instructions may be stored on a portable/removable storage media. The program instructions may be executed directly from the removable media or transferred to the local system memory or mass storages 1407 for subsequent execution. As such, the portable storage media, the local system memory, and the mass storages may be referred to as non-transitory computer readable storage mediums. The program instructions may be executed by one or more processors on a given workstation or they may be executed in a distributed fashion among the workstations, as desired.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A computer-accessible storage medium having program instructions stored therein that, in response to execution by a computer system, cause the computer system to perform operations including:
generating a statistical distribution of a first design parameter of a memory circuit;
generating a statistical distribution of a second design parameter of the memory circuit;
determining a first probability density function of the statistical distribution of the first design parameter;
determining a second probability density function of the statistical distribution of the second design parameter;
combining the first probability density function and the second probability density function to form a composite probability density function;
calculating a probability, dependent upon the composite probability density function, of a performance parameter of the memory circuit achieving a pre-determined performance value; and
optimizing a third design parameter of the memory circuit such that the probability is equal to a pre-determined goal.

2. The computer-accessible storage medium of claim 1, wherein generating the statistical distribution of the first design parameter or the second design parameter comprises running a Monte Carlo circuit simulation.

3. The computer-accessible storage medium of claim 1, wherein determining the first probability density function or the second probability density function comprises performing a curve fit.

4. The computer-accessible storage medium of claim 1, wherein combining the first probability density function and the second probability density function comprises multiplying the first probability density function and the second probability density function.

5. The computer-accessible storage medium of claim 1, wherein calculating the probability comprises numerically integrating the composite probability density function.

6. A method comprising:
performing by one or more computers:
determining a first probability density function corresponding to a statistical variation of a first design parameter of a circuit;
determining a second probability density function corresponding to a statistical variation of a second design parameter of the circuit;
combining the first probability density function and the second probability density function into a composite probability density function; and
optimizing a third design parameter of the circuit dependent upon the composite probability density function.

7. The method of claim 6, wherein the circuit comprises a memory circuit.

8. The method of claim 7, wherein the first design parameter comprises a bit line differential voltage, wherein the second design parameter comprises a minimum sense amplifier differential voltage, and wherein the third design parameter comprises a bit line development time.

9. The method of claim 7, wherein the first probability density function corresponds to a normally distributed probability density function.

10. The method of claim 7, wherein the second probability density function corresponds to an extreme value probability density function.

11. A system comprising:
one or more memories that, during operation, store instructions, and
one or more processors that, during operation, receive instructions from the one or more memories and execute the instructions to cause the system to perform operations comprising:
generating a first statistical distribution of the operation of a first part of a circuit;
generating a second statistical distribution of the operation of a second part of the circuit; and
optimizing a third part of the circuit dependent upon the first statistical distribution and the second statistical distribution.

12. The system of claim 11, wherein the first part of the circuit comprises a bit line of a memory circuit, wherein the second part of the circuit comprises a sense amplifier of the memory circuit, and wherein the third part of the circuit comprises a timing and control unit of the memory circuit.

13. The system of claim 12, wherein optimizing the third part of the circuit comprises one or more of: generating a first probability density function dependent upon the first statistical distribution, or generating a second probability density function dependent upon the second statistical distribution.

14. The system of claim 13, wherein optimizing the third part of the circuit further comprises multiplying the first probability density function by the second probability density function.

15. The system of claim 14, wherein optimizing the third part of the circuit further comprises modifying a development time dependent upon the product of the first probability density function and the second probability density function.

16. A computer-accessible storage medium having program instructions stored therein that, in response to execution by a computer system, cause the computer system to perform operations including:
generating a distribution of a minimum sense amplifier input signal voltage of a memory circuit;
generating a distribution of a bit line output signal voltage of the memory circuit;
converting the distribution of the minimum sense amplifier input signal voltage to a sense amplifier probability density function;
converting the distribution of the bit line output signal voltage to a bit line probability density function;
combining the sense amplifier probability density function and the bit line probability density function into a composite probability density function;
calculating, dependent upon the composite probability density function, a probability of a misread; and
optimizing a bit line output signal voltage development time such that the probability of a misread achieves a pre-determined probability goal.

17. The computer-accessible storage medium of claim 16, wherein calculating the probability of a misread comprises calculating a probability of the bit line output signal voltage achieving an output voltage.

18. The computer-accessible storage medium of claim 17, wherein calculating the probability of a misread further comprises, calculating a probability of the minimum sense amplifier input voltage matching the output voltage.

19. The computer-accessible storage medium of claim 18, wherein calculating the probability of a misread further comprises multiplying the probability of the bit line output signal voltage achieving an output voltage by the probability of the minimum sense amplifier input voltage matching the output voltage.

20. The computer-accessible storage medium of claim 19, wherein the probability of a misread is dependent upon a number of sense amplifiers included in the memory circuit.

21. A method comprising:
performing by one or more computers:
simulating a sense amplifier of a memory circuit to generate a statistical data of the minimum input voltage of the sense amplifier;
simulating a data storage cell of the memory circuit to generate a statistical data of the output voltage of the data storage cell;
determining a sense amplifier probability density function based in part upon the statistical data of the minimum input voltage of the sense amplifier;
determining a data storage cell probability density function based in part upon the statistical data of the output voltage of the data storage cell; and
calculating a probability of a read failure based in part upon the sense amplifier probability density function and the data storage cell probability density function.

22. The method of claim 21, wherein determining the sense amplifier probability density function comprises curve fitting the statistical data of the minimum input voltage of the sense amplifier.

23. The method of claim 22, wherein the sense amplifier probability density function is dependent upon one or more of a number of sense amplifiers or a number of redundant sense amplifiers.

24. The method of claim 21, wherein determining the data storage cell probability density function comprises curve fitting the statistical data of the output voltage of the data storage cell.

25. The method of claim 24, wherein the data storage cell probability density function is dependent upon one or more of a number of data storage cells or a number of redundant data storage cells.
